(19) United States
(12) Patent Application Publication
(10) Pub. No.: US 2019/0340621 A1
(43) Pub. Date: Nov. 7, 2019

(54) CONNECTION FULFILLMENT SYSTEM

(71) Applicant: CONNECT NOW, INC., Boston, MA (US)

(72) Inventor: Stephanie Sullivan, Boston, MA (US)

(21) Appl. No.: 16/403,991

(22) Filed: May 6, 2019

Related U.S. Application Data
(60) Provisional application No. 62/667,939, filed on May 7, 2018.

(51) Int. Cl. G06Q 30/00; G06Q 30/02; H04M 3/523; G06F 16/9537; G06F 9/451

(52) U.S. Cl. CPC G06Q 30/016; G06Q 30/0281; G06F 9/453; G06F 16/9537; H04M 3/5231

(57) ABSTRACT

Aspects and the present disclosure are directed to systems and methods for fulfilling a connection request which includes detecting, by a website server hosting a website, a user accessing the website through a first network connection, determining, through a respective second network connection, a respective availability of each of a plurality of professionals associated with the website, receiving, through the first network connection, a connection request from the user, assigning a respective ranking to each professional of the plurality of professionals, matching, based on the respective ranking, the user with a professional of the plurality of professionals, and connecting the professional with the user.

### CROSS-REFERENCE TO RELATED APPLICATION

This application claims priority under 35 U.S.C. § 119(e) to U.S. Provisional Application Ser. No. 62/667,939, titled “CONNECTION FULFILLMENT SYSTEM,” filed on May 7, 2018, which is hereby incorporated by reference in its entirety.

### BACKGROUND OF THE INVENTION

### 1. Field of the Invention

At least one example in accordance with the present invention relates generally to Internet-based service professional request fulfillment.

### 2. Discussion of Related Art

The advent of Internet-based technology services provides many day-to-day advantages, including the ability to quickly and easily exchange information with remote users. In some examples, website owners may generate and share a website oriented towards a specific technology or service area. For example, users may generate and share websites oriented towards real estate transactions, specific areas of law, and so forth.

### SUMMARY

According to at least one aspect of the present invention, a method of fulfilling a connection request is provided, the method including acts of detecting, by a website server hosting a website, a user accessing the website through a first network connection, determining, through a respective second network connection, a respective availability of each of a plurality of professionals associated with the website, receiving, through the first network connection, a connection request from the user, assigning a respective ranking to each professional of the plurality of professionals, matching, based on the respective ranking, the user with a professional of the plurality of professionals, and connecting the professional with the user.

In an example, matching the user with the professional includes providing a service request to each professional of the plurality of professionals, and receiving, from the professional, an acceptance of the service request. In one example, the ranking is based on a location of the user, and wherein matching the user with the professional includes providing a first service request to each professional of the plurality of professionals within a first geographical area, and providing, responsive to not receiving an acceptance of the first service request within a first period of time, a second service request to each professional of the plurality of professionals within a second geographical area.

In some examples, the ranking is based on an importance of the professional, and wherein matching the user with the professional includes providing a first service request to one or more professionals of the plurality of professionals having a highest level of importance, and providing, responsive to not receiving an acceptance of the first service request within a first period of time, a second service request to one or more professionals of the plurality of professionals having a next-highest level of importance. In at least one example, a level of importance is correlated to a service offered by the website.

In an example, the method includes providing feedback indicative of a plurality of connection requests, including the connection request, to a host of the website. In some examples, providing the feedback includes providing information indicative of a total number of connection requests of the plurality of connection requests and information indicative of a total number of connections of a plurality of connections resulting from the plurality of connection requests. In at least one example, providing the feedback further includes providing information indicative of a respective professional of the plurality of professionals corresponding to a respective connection of the plurality of connections.

According to aspects of the disclosure, a non-transitory computer-readable medium storing sequences of computer-executable instructions for fulfilling a connection request is provided, the sequences of computer-executable instructions including instructions that instruct at least one processor to detect a user accessing a website through a first network connection, determine a respective availability of each of a plurality of professionals associated with the website, receive a connection request from the user, assign a respective ranking to each professional of the plurality of professionals, match, based on the respective ranking, the user with a professional of the plurality of professionals, and connect the professional with the user.

In an example, in matching the user with the professional, the sequences of computer-executable instructions are further configured to instruct the at least one processor to provide a service request to each professional of the plurality of professionals, and receive, from the professional, an acceptance of the service request. In some examples, in instructing the at least one professor to match the user with the professional, the ranking is based on a location of the user, and the instructions are further configured to instruct the at least one processor to provide a first service request to each professional of the plurality of professionals within a first geographical area, and provide, responsive to not receiving an acceptance of the first service request within a first period of time, a second service request to each professional of the plurality of professionals within a second geographical area.

In some examples, in instructing the at least one professor to match the user with the professional, wherein the ranking is based on an importance of the professional, and wherein the instructions are further configured to instruct the at least one processor to provide a first service request to one or more professionals of the plurality of professionals having a highest level of importance, and provide, responsive to not receiving an acceptance of the first service request within a first period of time, a second service request to one or more professionals of the plurality of professionals having a next-highest level of importance. In one example, a level of importance is correlated to a service offered by the website.

In at least one example, the instructions are further configured to instruct the at least one processor to provide feedback indicative of a plurality of connection requests, including the connection request, to a host of the website. In some examples, in instructing the at least one professor to provide feedback, the instructions are further configured to instruct the at least one processor to provide information indicative of a total number of connection requests of the plurality of connection requests and information indicative of a total number of connections of a plurality of connections resulting from the plurality of connection requests. In an example, in instructing the at least one professor to provide feedback, the instructions are further configured to instruct the at least one processor to provide information indicative of a respective professional of the plurality of professionals corresponding to a respective connection of the plurality of connections.

According to aspects of the disclosure, a system is provided comprising a server including at least one processor, the at least one processor being configured to detect a user accessing a website through a first network connection, determine a respective availability of each of a plurality of professionals associated with the website, receive a connection request from the user, assign a respective ranking to each professional of the plurality of professionals, match, based on the respective ranking, the user with a professional of the plurality of professionals, and connect the professional with the user.

In an example, the at least one processor is further configured to provide a service request to each professional of the plurality of professionals, and receive, from the professional, an acceptance of the service request. In some examples, the ranking is based on a location of the user, and wherein the at least one processor is further configured to provide a first service request to each professional of the plurality of professionals within a first geographical area, and provide, responsive to not receiving an acceptance of the first service request within a first period of time, a second service request to each professional of the plurality of professionals within a second geographical area.

In at least one example, the ranking is based on an importance of the professional, and wherein the at least one processor is further configured to provide a first service request to one or more professionals of the plurality of professionals having a highest level of importance, and provide, responsive to not receiving an acceptance of the first service request within a first period of time, a second service request to one or more professionals of the plurality of professionals having a next-highest level of importance.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a service professional fulfillment environment according to an embodiment;

FIG. 2 illustrates a process of fulfilling a connection request according to an embodiment;

FIG. 3 illustrates a block diagram of a computer system;

FIG. 4 illustrates a host dashboard according to an embodiment;

FIG. 5 illustrates a lead report dashboard according to an embodiment;

FIG. 6 illustrates an agent report dashboard according to an embodiment; and

FIG. 7 illustrates a digital button according to an embodiment.

### DETAILED DESCRIPTION OF THE INVENTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are no intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As discussed above, websites may be generated and shared by Internet users. Websites oriented towards specific technology or service areas may be strictly informational in nature. In other examples, however, the website may serve as a platform through which professionals having expertise in the technology or service may be connected with Internet users interested in being connected with the technology or service professionals. For example, a real estate firm's website may provide information about specific areas of real estate transactions, and may invite Internet users to contact the firm directly for more information or professional services. In another example, a website may refer Internet users to third-party professionals having expertise in the given professional field, and may obtain a commission for referrals from the website. Conventional solutions for providing Internet-based service professional connection fulfillment may be considered relatively rudimentary in nature. For example, a real estate-oriented website may include information about certain areas of real estate transactions and may include static (for example, non-changing contact information) or dynamic contact information (for example, a randomly-selected advertisement containing contact information) inviting the Internet user to contact a firm or professional via a different medium (for example, via telephone).

However, conventional solutions are typically not customized to a user's preferences or interests beyond simple information, such as a location of the Internet user. Furthermore, conventional solutions lack information indicative of a service professional's availability. For example, an Internet user may be invited to contact a service professional who is on vacation, in a meeting, or otherwise unavailable. Internet users who are invited to contact service professionals that are not available or not specifically adept at solving problems unique to the Internet user may become discouraged from failed attempts to reach a professional and abandon their efforts, which may decrease user satisfaction with the host website.

An intelligent network-based service professional connection fulfillment system is provided. In one embodiment, a service professional connection fulfillment system may be accessed via a computer web browser of an Internet user. Upon navigating to a website providing professional services, the service professional connection fulfillment system may provide a user with an option to intelligently connect to a service professional without leaving the website providing the professional services, or may provide the user with contact information corresponding to a service professional. Embodiments disclosed herein may be considered particularly advantageous with respect to addressing various problems arising in the realm of network-based service professional fulfillment by capitalizing on information which may be obtained via network-based interactions to maximize user satisfaction with the website.

Embodiments disclosed herein may also be considered particularly advantageous to website hosts and website agents. For example, by increasing user satisfaction with the website, website traffic may be increased and visitor retention may be increased. In some embodiments, information may be collected and provided to the website host including visitor information, service professional information, and visitor-professional connection information. Website agents may also benefit by enjoying an increased volume of business connections driven by the connection fulfillment system, and may have access to information describing connections that they have had with website visitors.

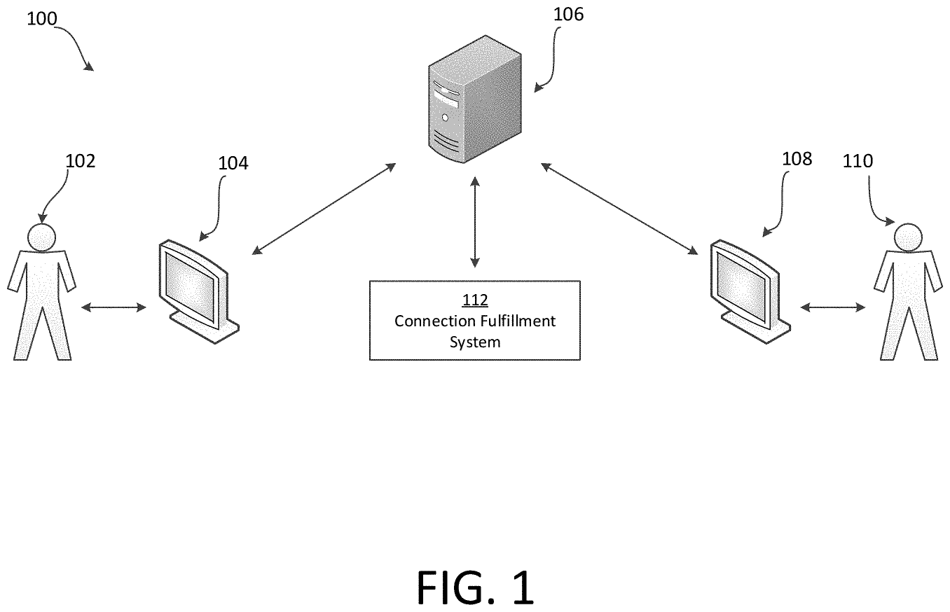

FIG. 1 illustrates a service professional fulfillment environment 100 according to an embodiment. The environment 100 includes an Internet user 102, a first electronic device 104, a website server 106, a second electronic device 108, a service professional 110, and a connection fulfillment system 112.

The website server 106 is communicatively coupled to the first electronic device 104, the second electronic device 108, and the connection fulfillment system 112. For example, the website server 106 may be communicatively coupled to the first electronic device 104, the second electronic device 108, and the connection fulfillment system 112 via a computer network connection, such as an Internet connection. The connection fulfillment system 112 is communicatively coupled to the first electronic device 104, the second electronic device 108, and the website server 106. For example, the connection fulfillment system 112 may be communicatively coupled to the first electronic device 104, the second electronic device 108, and the website server 106 via a computer network connection, such as an Internet connection. The first electronic device 104 and the second electronic device 108 are each configured to be communicatively coupled to the website server 106 and the connection fulfillment system 112. For example, the first electronic device 104 and the second electronic device 108 may each be configured to be coupled to the website server 106 and the connection fulfillment system 112 via a computer network connection, such as an Internet connection.

In at least one embodiment, the connection fulfillment system 112 may be hosted by the website server 106. The first electronic device 104 may execute a web browser which includes a browser extension configured to communicate with the connection fulfillment system 112. For example, the browser extension may be a JavaScript plug-in configured to communicate with the connection fulfillment system 112 through an Application Programming Interface (API) of the connection fulfillment system 112. The second electronic device 108 may execute an application (for example, a smartphone application) configured to communicate with the connection fulfillment system 112.

In one embodiment, the website server 106 may also host a website and may maintain Customer Relationship Management (CRM) information about users who access the website. The website may be designed to provide information about a specific topic to users. As discussed above, it may be advantageous to be able to connect users viewing a website about a specific topic with service professionals having expertise in the specific topic. For example, the website server 106 may host a website directed to a topic which the service professional 110 has expertise in, and the connection fulfillment system 112 may therefore be able to connect the service professional 110 to users of the website, as discussed in greater detail below.

In some examples, the first electronic device 104 and the second electronic device 108 are configured to receive inputs from, and provide inputs to, the Internet user 102 and the service professional 110, respectively. For example, the first electronic device 104 and the second electronic device 108 may include, or be otherwise coupled to, one or more peripheral devices configured to receive inputs from, or provide inputs to, the Internet user 102 and the service professional 110, respectively.

Peripheral devices may include, for example, computer keyboards, computer mice, monitor displays, touch screens, and so forth. In some embodiments, the first electronic device 104 and/or the second electronic device 108 may be implemented in connection with a desktop computer, a laptop computer, a mobile electronic device (for example, a smartphone), or other electronic device capable of communicating via remote computer networks such as the Internet.

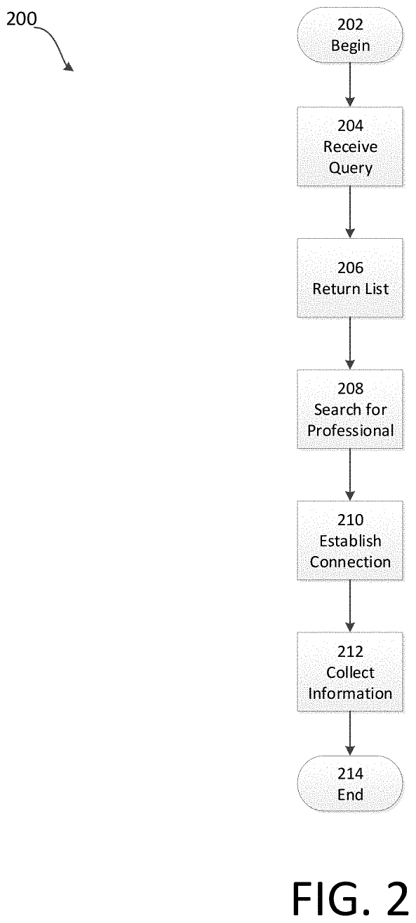

The Internet user 102 may access the website server 106 via the first electronic device 104 to view the website, and may wish to connect with a service professional, such as the service professional 110, having expertise in the topic featured on the website. As discussed in greater detail below, the Internet user 102 may request, via a combination of the first electronic device 104 and the connection fulfillment system 112, to be connected to a service professional. The connection fulfillment system 112 may intelligently determine service professionals' availability and, based on information about the Internet user 102 and based on the service professional's 110 expertise and availability, connect the Internet user 102 with the service professional 110. FIG. 2 illustrates a process 200 of fulfilling a service professional connection request according to an embodiment. The process 200 may be executed by the connection fulfillment system 112, for example. At act 202, the process 200 begins. At act 204, a service professional query is received. For example, the service professional query may be received from the first electronic device 104 periodically to poll the connection fulfillment system 112 for service professionals' availability. In one embodiment, the connection fulfillment system 112 may include an API configured to receive calls from the first electronic device 104 regarding service professionals' availability when the first electronic device 104 is connected to website servers that have been configured to allow users to connect with service professionals. For example, to configure the website servers, website owners may add JavaScript code to a website hosted by the website servers, or may use a plugin or widget (for example, a WordPress plugin).

Service professionals may be able to manually configure their current availability by toggling a presence indicator via the second electronic device 108. For example, where the second electronic device 108 is a smartphone, the service professional 110 may toggle a presence indicator through a smartphone application configured to interface with the connection fulfillment system 112.

At act 206, a list of available service professionals is returned to the originator of the service professional query received at act 204. For example, where the connection fulfillment system 112 receives the service professional query from the first electronic device 104, the connection fulfillment system 112 may return a list of service professionals that are currently available. The connection fulfillment system 112 may also provide information about the service professionals in the list of service professionals including, for example, name, phone number, and so forth.

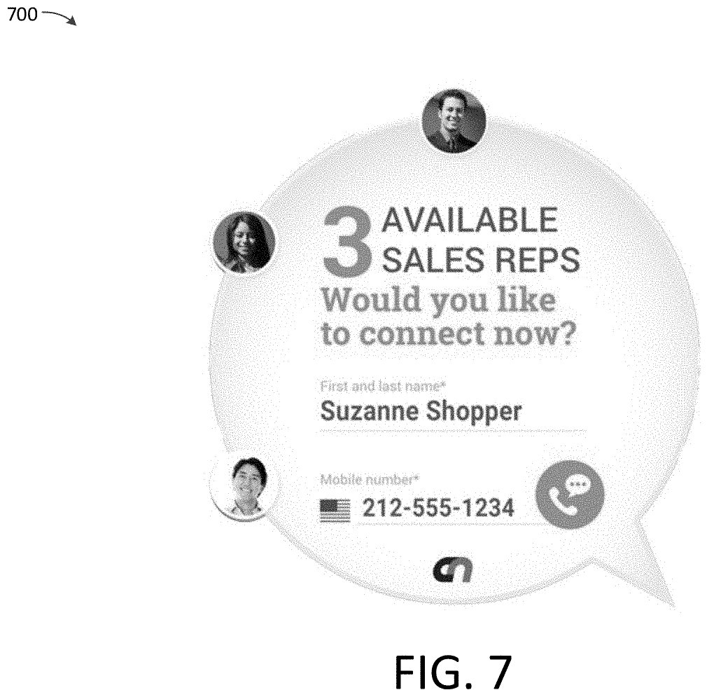

Upon receiving the list of service professionals, the first electronic device 104 may invite the Internet user 102 to connect to a service professional. The invitation may be a digital “Connect Now” button for example, displayed by the first electronic device 104. FIG. 7 illustrates an exemplary digital button 700 which may be displayed by the first electronic device 104. The Internet user 102 may initiate a connection to a service professional by interacting with the “Connect Now” button.

Before a connection with a service professional is established, the first electronic device 104 may request certain information from the Internet user 102. For example, as illustrated by the digital button 700, a user's phone number and name may be requested. In other example, other additional information may be requested such as an email address or any additional requested information. Where the Internet user 102 is viewing a website hosted by the website server 106, the additional requested information may be at least partially configured by the owner of the website server 106.

For example, where the website hosted by the website server 106 is directed to real estate transactions, the additional requested information may include a requested budget range. In some examples, the first electronic device 104 may also send information to the website server 106 which is not explicitly requested from or provided by the Internet user 102, such as the website page that the Internet user 102 was on when making the request, or the particular product that the Internet user 102 was making the request.

At act 208, a determination is made as to which service professional to connect to the Internet user 102 responsive to receiving the information from the user. For example, searching for a service professional to connect to the Internet user 102 may include providing a notification from the connection fulfillment system 112 to all of the available service professionals on the list of available service professionals requesting that a service professional be connected with the Internet user 102 established in connection with act 206, above. The first service professional to accept the request may be connected to the Internet user 102. While the Internet user 102 awaits the establishment of the connection, pre-recorded video content may be displayed to the Internet user 102, such as video advertisements provided by the website server 106.

At act 210, a connection is established between the Internet user 102 and a service professional. For example, the Internet user 102 may be connected to the service professional 110. In some embodiments, when the service professional 110 accepts the request to be connected with the Internet user 102, the service professional may be presented with information about the Internet user 102, including their contact information and what services they are specifically interested in. The service professional 110 may then contact the Internet user 102 using the contact information provided, such as by phone, email, video conferencing, and so forth.

At act 212, information may be collected about the interaction. For example, if the connection fulfillment system 112 connects the Internet user 102 with the service professional 110, the website server 106 may store information indicative of the connection in a CRM database. If the Internet user 102 subsequently requests to be connected with a service professional via the website server 106 again, the connection fulfillment system 112 may determine using the CRM information stored in the CRM database that the Internet user 102 has already spoken with the service professional 110. Accordingly, the connection fulfillment system 112 may subsequently connect the Internet user 102 with the service professional 110 because the parties have already established a rapport. At act 214, the process 200 ends.

Various modifications to the process 200 may be provided in alternate embodiments. For example, as discussed above, the Internet user 102 may be connected with the first available service professional to answer a connection request. In other embodiments, the Internet user 102 may be connected with a service professional having expertise more particularly suited to the Internet user 102 based on information about the Internet user 102 collected by the website server 106.

The CRM information may be obtained by the website server 106 as the Internet user uses the website hosted by the website server 106. The CRM information may be affirmatively collected from the Internet user (for example, by requesting that the Internet user provide information) or passively collected from the Internet user (for example, by obtaining information about the Internet user without the Internet user affirmatively providing the information to the website server 106).

CRM information may include, for example, geographical location information, preferred language information, historical transaction information with the website hosted by the website server 106, or any other information which may aid in maximizing the value of the service provided to the Internet user. Accordingly, where the Internet user 102 is connected to a service professional specifically tailored to the CRM information, the Internet user 102 may have a more productive connection with the service professional.

As discussed above, service professionals may be able to specify their availability to the connection fulfillment system 112, such as by toggling a presence indicator between an available status and an unavailable status. In other examples, the connection fulfillment system 112 may automatically determine the service professional's 110 availability in addition to, or in lieu of, receiving a presence indication from the service professional 110. For example, the connection fulfillment system 112 may determine that the service professional 110 is actively on a telephone call, and that the service professional 110 is therefore unavailable.

As discussed above with respect to act 208, the connection fulfillment system 112 is configured to connect the Internet user 102 with an available service professional by transmitting a notification to available service professionals. In some examples, the connection fulfillment system 112 may transmit the notification to all available service professionals. In other examples, the connection fulfillment system 112 may transmit the notification to available service professionals in a progressive manner based on one or more criteria. Service professionals may be ranked into one or more tiers based on the one or more criteria.

For example, a criterion may include an importance of the service professional to a relevant transaction. The importance of the service professional may be correlated to a service offered by a website that the Internet user 102 is viewing. For example, where the Internet user 102 is browsing a real estate website page featuring a home for sale listed by a real estate listing agent, the listing agent may be a most important service professional and thus be ranked into a highest tier to be contacted first. If the listing agent does not accept the connection request, then the connection request may be sent to a next-most-important person or persons ranked in a second tier, such as the listing agent's assistant. If the listing agent's assistant does not accept the connection request, then the connection request may be sent to one or more other professionals that work with the listing agent (for example, the listing agent's team) ranked into a third tier, and so forth.

In another example, the criterion may include geographical proximity. For example, the connection fulfillment system 112 may transmit the notification to available service professionals within a first geographical area (for example, within a five-mile radius of the Internet user 102). If none of the available service professionals within the first geographical area respond to the notification within a first period of time (for example, 30 seconds), then the connection fulfillment system 112 may transmit a notification to available service professionals within a second geographical area (for example, within a ten-mile radius of the Internet user 102) for a second period of time (for example, one minute). The connection fulfillment system 112 may continue to expand the geographical area in which service professionals are notified until a service professional contacts the Internet user 102.

An example implementation of the process 200 will now be described. In one example, the Internet user 102 is interested in buying a house in Massachusetts and is reviewing, via a web browser on the first electronic device 104, an article about the Massachusetts housing market on a website hosted by the website server 106. The website server 106 may be collecting information about the Internet user while the Internet user reviews the article, and may be storing the information in a CRM information database coupled to the website server 106. For example, the website server 106 may determine that the Internet user is in Boston, Mass. based on location information passively collected from the Internet user. The website server 106 may also determine that the Internet user is interested in buying, rather than renting, a home based on information affirmatively requested from the Internet user.

While the Internet user 102 browses the website, the connection fulfillment system 112 searches for available services professionals having expertise in a relevant field. The specificity of the relevancy of the field may be variable. For example, in some embodiments, a relevant field may be real estate transactions. In other embodiments, the relevant field may be real estate transactions in Massachusetts. In still other embodiments, the relevant field may be real estate transactions in Massachusetts from a buyers' perspective. Upon determining a relevant field, the connection fulfillment system 112 determines which service professionals having expertise in the relevant field are available. For example, the connection fulfillment system 112 may determine which, if any, service professionals have indicated that they are available using a presence indicator via the second electronic device 108.

Upon determining which service professionals are available, the connection fulfillment system 112 may determine which of the available service professionals is most suitable to the Internet user's 102 needs. For example, as discussed above, the connection fulfillment system 112 may obtain the CRM information about the Internet user 102 from the website server 106, and may determine from the CRM information that the Internet user 102 is interested in buying a home in Massachusetts. Based on the CRM information, the connection fulfillment system 112 may match the Internet user 102 with at least one available service professional who has expertise in buying real estate in or around Boston, Mass.

Once the connection fulfillment system 112 determines that the Internet user 102 is eligible to be matched with at least one service professional, the connection fulfillment system 112 may provide the Internet user 102 with the option to connect with the service professional 110. For example, the connection fulfillment system 112 may display a “Connect Now” button to the Internet user 102 via the first electronic device 104.

If the Internet user 102 selects the “Connect Now” button, then each of the available service professionals is provided, via the connection fulfillment system 112, with a notification that the Internet user 102 wishes to connect. In some embodiments, the Internet user 102 may be required to enter contact information, such as a name, phone number, or e-mail address, prior to submitting the connection request.

Once a service professional such as the service professional 110 accepts, or “claims,” the request, no other service professionals may accept the request. The service professional 110 is provided with contact information to connect with the Internet user 102. For example, the service professional 110 may be able to connect with the Internet user 102 by calling or emailing the Internet user 102. Once the interaction between the service professional 110 and the Internet user 102 concludes, the website server 106 receives information about the interaction including, for example, the method of connection, the duration of the connection, and so forth.

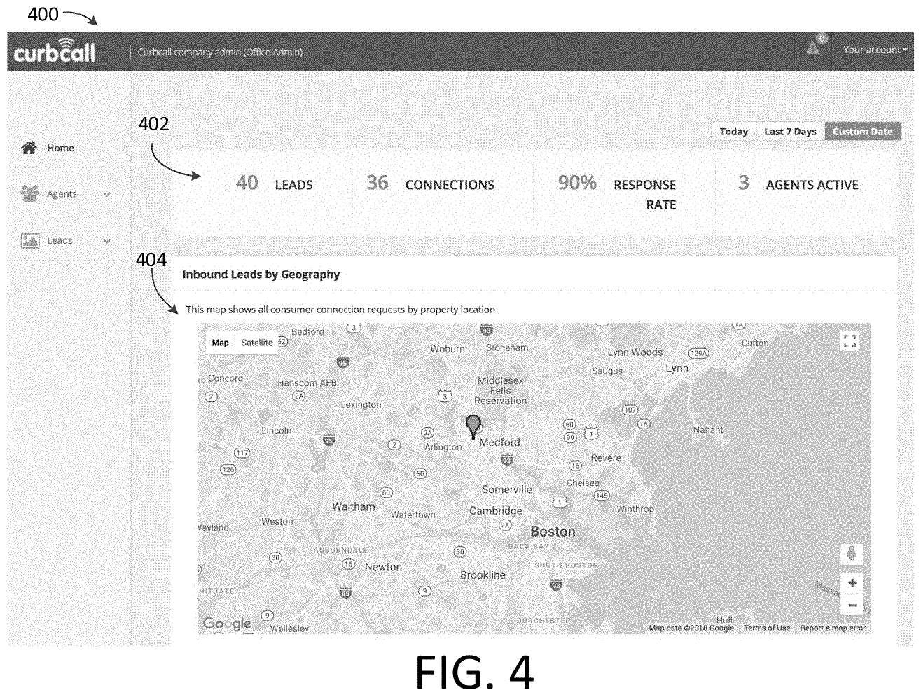

A host of the website server 106 may be able to receive and review information collected by the connection fulfillment system 112 and stored in the website server 106. For example, FIG. 4 illustrates a host dashboard 400 according to an embodiment. The host dashboard 400 includes a connection information section 402 and a geographical information section 404. The connection information section 402 is configured to provide information indicative of connections established between users and service professionals. The geographical information section 404 is configured to provide information indicative of a geographical location associated with a connection between a user and a service professional.

In one example, the connection information section 404 displays lead information, connection information, response rate information, and active agent information. The lead information is indicative of a number of users that have requested to be connected to a service professional. The connection information is indicative of a number of requests that have been claimed. The response rate information is indicative of a response rate from service professionals. For example, the response rate information may indicate a number of requests that have been claimed divided by a number of connection requests. The active agent information is indicative of a number of service professionals that are currently active.

The geographical information section 404 may indicate geographic information relating to one or more connections. For example, where the host using the host dashboard 400 is affiliated with a real estate brokerage, the geographical information section 404 may indicate locations from which requests have been received. Alternatively or in addition, the geographical information section 404 may indicate (for example, indicate using a “pin,” or marker, on a map) properties advertised by the host which prompted the user to submit the connection request. For example, where the user requested to be connected to a service professional while viewing a particular housing unit, the geographical information section 404 may indicate a pin where the particular housing unit is located.

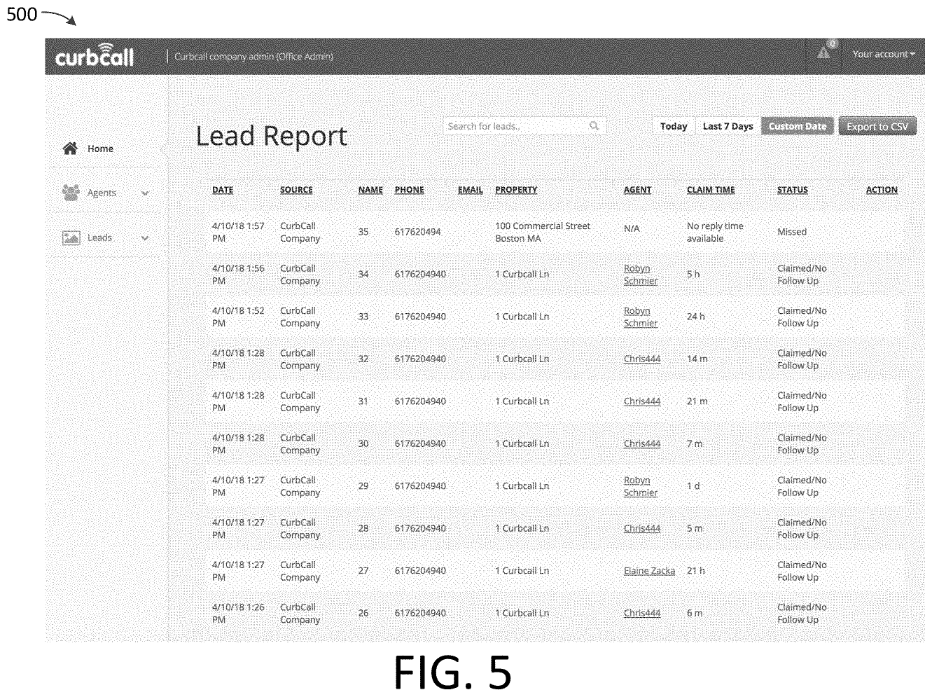

FIG. 5 illustrates a lead report dashboard 500 according to an embodiment. In one example, the lead report dashboard 500 is configured to provide information to a host regarding connection requests in tabular form. For example, the lead report dashboard 500 may include date information, source information, name information, phone number information, email information, property information, agent information, claim time information, status information, and action information.

The date information may indicate a date at which a connection request was submitted by a user. In some embodiments, the date information also includes a time at which the connection request was submitted. The source information may indicate a source of the connection request. For example, the source information may indicate a website from which a user submitted a connection request. The name information may indicate a name of a user submitting the connection request.

The phone number information may indicate a phone number of a user submitting the connection request. The email information may include email information of a user submitting the connection request. The property information may indicate a property pertaining to a connection request. For example, where the lead report dashboard 500 is associated with a real estate firm, the property information may indicate a property which the user submitting the connection request is interested in.

The agent information indicates a service professional who claimed the connection request. In some embodiments, if a service professional does not claim a connection request, the agent information may be left blank. In alternate embodiments, the agent information may include information indicative of the fact that a service professional did not claim a connection request. For example, the agent information may include “N/A,” or “not available.” The claim time indicates an elapsed time between when a user submits a connection request, and when a service professional claims the connection request. If a connection request is not claimed, the claim time may be blank, or include information indicating that the connection request was not claimed.

The status information may indicate a status of a connection request. For example, if a connection request is claimed, then the status may indicate that the connection request was claimed, such as by including the language “claimed.” The status information may further indicate whether any follow-up occurred between the user and the service professional. For example, follow-up may include any interaction between the user and the service professional subsequent to an initial connection. The status information may further include information indicative of a missed connection request if a connection request is not claimed, such as by including the language “missed.”

The action information may include any information indicative of an action taken in connection with the connection. For example, the action information may include information indicative of a medium through which a user and a service professional were connected. Specific examples of action information may include “call,” “text,” and “email.”

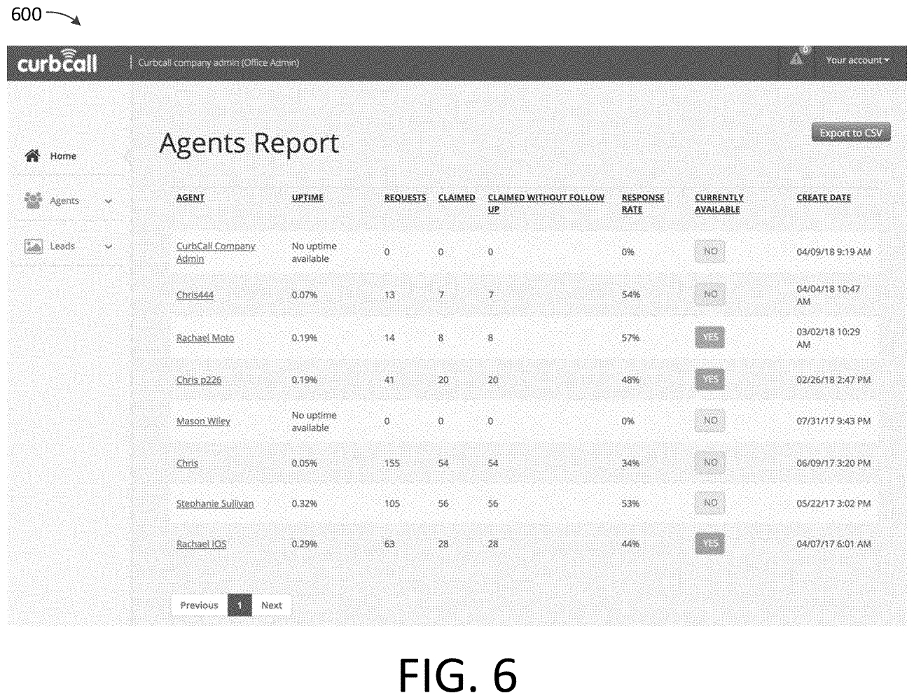

FIG. 6 illustrates an agent report dashboard 600 according to an embodiment. In one example, the agent report dashboard 600 is configured to provide agent information, uptime information, request information, first claim information, second claim information, response information, availability information, and creation date information.

The agent information may include information indicative of a service professional. For example, the agent information may include a name of a service professional, or other information indicative of a service professional's identity. The uptime information may indicate an amount of time that the service professional listed in connection with the agent information is available. For example, the uptime information may include a percentage of time that a service professional is listed as being available, such as by dividing an amount of time in a first block of time that a service professional was listed as available by the first block of time. The first block of time may be measured over a configurable window of time, including a rolling 24-hour period, a rolling 1-month period, a total amount of time since creation of the service professional's account, or any other window of time.

The request information may include information indicative of a total number of requests that a service professional has received. The first claim information may include information indicative of a number of received connection requests that the service professional has claimed. The second claim information may include information indicative of a number of claimed requests which the service professional has not followed-up on. As discussed above, follow-up may include a connection between a service professional and a user subsequent to an initial connection.

The response rate information may include information indicative of a rate at which service professionals respond to received connection requests. For example, the response rate information may be a percentage value indicative of a number of claimed requests divided by a total number of received requests. The availability information may indicate a present availability of a service professional. For example, the availability information may display the words “Available” or “Yes” if the service professional is available, or “Unavailable” or “No” if the service professional is unavailable. The creation date information may include information indicative of a date at which a service professional account is created. In some examples, the creation date information may further include a time at which an account is created.

In some embodiments, the service professionals may also be able to access information collected by the connection fulfillment system 112. However, service professionals will only be allowed to view information collected by the connection fulfillment system 112 which is pertinent to the service professional. For example, the service professional may be provided with a dashboard which displays their average percentage of availability, average connection duration, typical means of connection, average time for a service professional to claim a request, and so forth.

In light of the foregoing, a connection fulfillment system has been disclosed. The connection fulfillment system is particularly advantageous in connection with an Internet-based environment. For example, because the connection fulfillment system is capable of collecting user information and service professionals' availability in real time, a user in need of professional assistance may be connected with a service professional uniquely suited to the user's needs in a very short time frame. Moreover, the user may not need to leave the web page through which a service professional is discovered, which may be advantageous to the website host to increase website traffic.

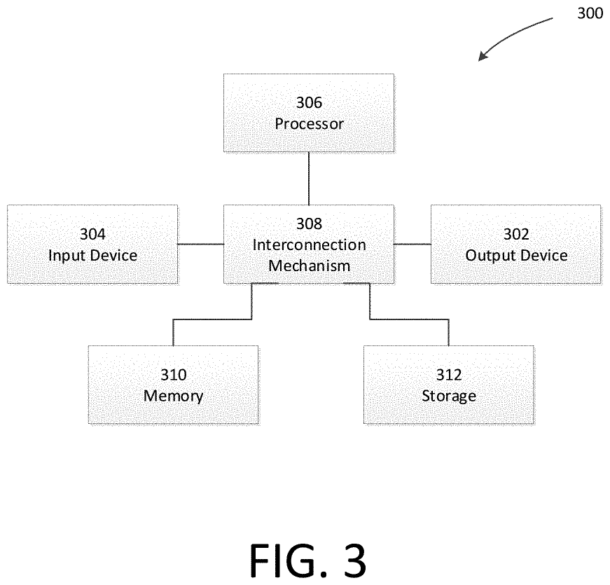

As discussed above, the connection fulfillment system 112 may be hosted by the website server 106. FIG. 3 illustrates a block diagram of a computer system 300. In some embodiments, the website server 106 may be implemented as the computer system 300. As shown, the computer system 300 includes a processor 302, one or more memory elements 304, an interconnection element 306, one or more interface devices 308 coupled to a communication network 312, and a data storage element 310. As shown, the computer system 300 is connected to, and may exchange data through, the communication network 312. For example, the computer system 300 may be coupled to one or both of the first electronic device 104 and the second electronic device 108 through the communication network 312. The communication network 312 may include any communication network through which computer systems may exchange data.

To exchange data using the communication network 312, the computer system 300 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer system 300 may transmit data via the communication network 312 using a variety of security measures including, for example, TLS, SSL or VPN.

To implement at least some of the aspects, functions and processes disclosed herein, the processor 302 performs a series of instructions that result in manipulated data. The processor 302 may be any type of processor, multiprocessor or controller. Some example processors include commercially available processors such as an Intel Atom, Itanium, Core, Celeron, or Pentium processor, an AMD Opteron processor, an Apple A4 or A5 processor, an Oracle UltraSPARC or IBM Power5+ processor and an IBM mainframe chip. The processor 302 is connected to other system components, including the one or more memory elements 304, by the interconnection element 306.

The one or more memory elements 304 store programs and data during operation of the computer system 300. Thus, the one or more memory elements 304 may be relatively high performance, volatile, random access memory such as dynamic random access memory (“DRAM”) or static memory (“SRAM”). However, the one or more memory elements 304 may include any device for storing data, such as a disk drive or other nonvolatile storage device. Various examples may organize the one or more memory elements 304 into particularized and, in some cases, unique structures to perform the functions disclosed herein. These data structures may be sized and organized to store values for particular data and types of data.

Components of the computer system 300 are coupled by an interconnection element such as the interconnection element 306. The interconnection element 306 may include one or more physical busses, for example, busses between components that are integrated within a same machine, but may include any communication coupling between system elements including specialized or standard computing bus technologies such as IDE, SCSI, PCI and InfiniBand. The interconnection element 306 enables communications, such as data and instructions, to be exchanged between system components of the computer system 300.

The computer system 300 also includes the one or more interface devices 308 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, and so forth. Interface devices allow the computer system 300 to exchange information and to communicate with external entities, such as users and other systems.

The data storage element 310 includes a computer readable and writeable nonvolatile, or non-transitory, data storage medium in which instructions are stored that define a program or other object that is executed by the processor 302. The data storage element 310 also may include information that is recorded, on or in, the medium, and that is processed by the processor 302 during execution of the program. More specifically, the information may be stored in one or more data structures specifically configured to conserve storage space or increase data exchange performance. The instructions may be persistently stored as encoded signals, and the instructions may cause the processor 302 to perform any of the functions described herein. The medium may, for example, be optical disk, magnetic disk or flash memory, among others. In operation, the processor 302 or some other controller causes data to be read from the nonvolatile recording medium into other memory, such as the one or more memory elements 304, that allows for faster access to the information by the processor 302 than does the storage medium included in the data storage element 310. The memory may be located in the data storage element 310 or in the one or more memory elements 304, however, the processor 302 manipulates the data within the memory, and then copies the data to the storage medium associated with the data storage element 310 after processing is completed. A variety of components may manage data movement between the storage medium and other memory elements and examples are not limited to particular data management components. Further, examples are not limited to a particular memory system or data storage system.

Although the computer system 300 is shown by way of example as one type of computer system upon which various aspects and functions may be practiced, aspects and functions are not limited to being implemented on the computer system 300. Various aspects and functions may be practiced on one or more computers having a different architectures or components than that shown in FIG. 3. For instance, the computer system 300 may include specially programmed, special-purpose hardware, such as an application-specific integrated circuit (“ASIC”) tailored to perform a particular operation disclosed herein. While another example may perform the same function using a grid of several computing devices running MAC OS X with IBM PowerPC processors and several specialized computing devices running proprietary hardware and operating systems.

The computer system 300 may be a computer system including an operating system that manages at least a portion of the hardware elements included in the computer system 300. In some examples, a processor or controller, such as the processor 302, executes an operating system. Examples of a particular operating system that may be executed include a Windows-based operating system, such as the Windows 10 operating system, available from the Microsoft Corporation, a MAC OS X operating system or an iOS operating system available from Apple Computer, one of many Linux-based operating system distributions, for example, the Enterprise Linux operating system available from Red Hat Inc., a Solaris operating system available from Oracle, or a UNIX operating systems available from various sources. Many other operating systems may be used, and examples are not limited to any particular operating system.

The processor 302 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using programming languages such as .Net, SmallTalk, Java, JavaScript, C++, Ada, C# (C-Sharp), or Python. Other programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++ or Python. Thus, the examples are not limited to a specific programming language and any suitable programming language could be used. Accordingly, the functional components disclosed herein may include a wide variety of elements, e.g. specialized hardware, executable code, data structures or objects, which are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Although at least one embodiment has been disclosed with respect to real estate transactions, alternate embodiments may be implemented in alternate fields. For example, in some embodiments, a connection fulfillment system may be implemented in connection with legal services or automotive sales.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the scope of the disclosure. Accordingly, the foregoing description and drawings are by way of example only.

What is claimed is:

1. A method of fulfilling a connection request, the method including acts of:
detecting, by a website server hosting a website, a user accessing the website through a first network connection;
determining, through a respective second network connection, a respective availability of each of a plurality of professionals associated with the website;
receiving, through the first network connection, a connection request from the user;
assigning a respective ranking to each professional of the plurality of professionals;
matching, based on the respective ranking, the user with a professional of the plurality of professionals; and
connecting the professional with the user.

2. The method of claim 1, wherein matching the user with the professional includes:
providing a service request to each professional of the plurality of professionals; and
receiving, from the professional, an acceptance of the service request.

3. The method of claim 1, wherein the ranking is based on a location of the user, and wherein matching the user with the professional includes:
providing a first service request to each professional of the plurality of professionals within a first geographical area; and
providing, responsive to not receiving an acceptance of the first service request within a first period of time, a second service request to each professional of the plurality of professionals within a second geographical area.

4. The method of claim 1, wherein the ranking is based on an importance of the professional, and wherein matching the user with the professional includes:
providing a first service request to one or more professionals of the plurality of professionals having a highest level of importance; and
providing, responsive to not receiving an acceptance of the first service request within a first period of time, a second service request to one or more professionals of the plurality of professionals having a next-highest level of importance.

5. The method of claim 4, wherein a level of importance is correlated to a service offered by the website.

6. The method of claim 1, further comprising providing feedback indicative of a plurality of connection requests, including the connection request, to a host of the website.

7. The method of claim 6, wherein providing the feedback includes providing information indicative of a total number of connection requests of the plurality of connection requests and information indicative of a total number of connections of a plurality of connections resulting from the plurality of connection requests.

8. The method of claim 7, wherein providing the feedback further includes providing information indicative of a respective professional of the plurality of professionals corresponding to a respective connection of the plurality of connections.

9. A non-transitory computer-readable medium storing sequences of computer-executable instructions for fulfilling a connection request, the sequences of computer-executable instructions including instructions that instruct at least one processor to:
detect a user accessing a website through a first network connection;
determine a respective availability of each of a plurality of professionals associated with the website;
receive a connection request from the user;
assign a respective ranking to each professional of the plurality of professionals;
match, based on the respective ranking, the user with a professional of the plurality of professionals; and
connect the professional with the user.

10. The non-transitory computer-readable medium of claim 9, wherein in matching the user with the professional, the sequences of computer-executable instructions are further configured to instruct the at least one processor to:
provide a service request to each professional of the plurality of professionals; and
receive, from the professional, an acceptance of the service request.

11. The non-transitory computer-readable medium of claim 9, wherein in instructing the at least one professor to match the user with the professional, the ranking is based on a location of the user, and the instructions are further configured to instruct the at least one processor to:
provide a first service request to each professional of the plurality of professionals within a first geographical area; and
provide, responsive to not receiving an acceptance of the first service request within a first period of time, a second service request to each professional of the plurality of professionals within a second geographical area.

12. The non-transitory computer-readable medium of claim 9, wherein in instructing the at least one professor to match the user with the professional, wherein the ranking is based on an importance of the professional, and wherein the instructions are further configured to instruct the at least one processor to:
provide a first service request to one or more professionals of the plurality of professionals having a highest level of importance; and
provide, responsive to not receiving an acceptance of the first service request within a first period of time, a second service request to one or more professionals of the plurality of professionals having a next-highest level of importance.

13. The non-transitory computer-readable medium of claim 12, wherein a level of importance is correlated to a service offered by the website.

14. The non-transitory computer-readable medium of claim 9, wherein the instructions are further configured to instruct the at least one processor to provide feedback indicative of a plurality of connection requests, including the connection request, to a host of the website.

15. The non-transitory computer-readable medium of claim 14, wherein in instructing the at least one professor to provide feedback, the instructions are further configured to instruct the at least one processor to:
provide information indicative of a total number of connection requests of the plurality of connection requests and information indicative of a total number of connections of a plurality of connections resulting from the plurality of connection requests.

16. The non-transitory computer-readable medium of claim 15, wherein in instructing the at least one professor to provide feedback, the instructions are further configured to instruct the at least one processor to provide information indicative of a respective professional of the plurality of professionals corresponding to a respective connection of the plurality of connections.

17. A system comprising:
a server including at least one processor, the at least one processor being configured to:
detect a user accessing a website through a first network connection;
determine a respective availability of each of a plurality of professionals associated with the website;
receive a connection request from the user;
assign a respective ranking to each professional of the plurality of professionals;
match, based on the respective ranking, the user with a professional of the plurality of professionals; and
connect the professional with the user.

18. The system of claim 17, wherein the at least one processor is further configured to:
provide a service request to each professional of the plurality of professionals; and
receive, from the professional, an acceptance of the service request.

19. The system of claim 17, wherein the ranking is based on a location of the user, and wherein the at least one processor is further configured to:
provide a first service request to each professional of the plurality of professionals within a first geographical area; and
provide, responsive to not receiving an acceptance of the first service request within a first period of time, a second service request to each professional of the plurality of professionals within a second geographical area.

20. The system of claim 17, wherein the ranking is based on an importance of the professional, and wherein the at least one processor is further configured to:
provide a first service request to one or more professionals of the plurality of professionals having a highest level of importance; and
provide, responsive to not receiving an acceptance of the first service request within a first period of time, a second service request to one or more professionals of the plurality of professionals having a next-highest level of importance.
